(19) United States
(12) Patent Application Publication
(10) Pub. No.: US 2005/0064070 A1
(43) Pub. Date: Mar. 24, 2005

(54) Beverage compositions for use in rehydration and nutrition during athletic exercise and methods of making same

(76) Inventor: Jeffrey Liebrecht, Columbus, OH (US)

Correspondence Address: Jeffrey C. Maynard, 154 Barbara Road, Severna Park, MD, 21146, US

(21) Appl. No.: 10/358,871

(22) Filed: Feb. 5, 2003

Related U.S. Application Data
(60) Provisional application No. 60/417,765, filed on Oct. 11, 2002.

(51) Int. Cl. A23L 1/30

(52) U.S. Cl. 426/72

(57) ABSTRACT

This invention relates to novel beverage compositions and methods to make such beverage compositions that can be used to reduce or prevent adverse physiological effects of physical exercise or environmental exposure by providing a beverage composition for use in rehydration and nutrition before, during, or after athletic exercise. The novel compositions comprise fluids containing water, sugar including carbohydrates, such as fructose and raftilose, and electrolytes, such as zinc, chromium, copper, potassium, magnesium, sodium, and citric acid. Such beverage can act as an energy source for the consumer.

### CROSS REFERENCE TO RELATED APPLICATION

This application claims the benefit of U.S. Provisional Application Ser. No. 60/417,765 entitled Beverage Compositions for Use in Rehydration and Nutrition During Athletic Exercise and Methods of Making Same, filed with the U.S. Patent and Trademark Office on Oct. 11, 2002.

### BACKGROUND OF THE INVENTION

1. Field of the Invention

This invention relates to an electrolyte drink useful for replenishing the major constituents lost from body fluids as a result of metabolic processes, in particular the invention relates to an electrolyte drink for consumption before, during and after athletic exercise.

2. Background of the Prior Art

Physical exercise can be distinguished in different categories i.e. those requiring strength, strength and speed or endurance. In practice, this can be heavy work, muscle activity under severe conditions (e.g. high temperature, high altitude), leisure sports or athletic performance.

During relatively extended periods of heavy muscle work, the work capacity of an individual is limited by several factors, such as too low blood sugar concentration and loss of liquid by transpiration. In the last decade, the use of liquid drinks containing electrolytes in the form of carbohydrates during exercise has become increasingly accepted as a stimulus during endurance performance. As a result, these days it is general practice to ingest substantial amounts of sugar, salt and other electrolytes in a liquid form during endurance competition events. Supplementation with carbohydrate containing fluids is employed to prolong exercise and improve the performance of high intensity endurance exercise. Benefits to be obtained are maintenance of fluid balance and an increase in the availability of carbohydrate.

Three different periods of intake can be defined as pre-exercise intake, intake during exercise and post-exercise intake. beverages are ingested prior to exercise in an attempt to prevent detrimental changes, which can accompany exercise. The efficiency of ingested glucose in enhancing physical performance is dependent on the time at which the beverage is ingested before exercise. Glucose containing beverages produce an increase in plasma glucose peaking approximately 45 minutes after ingestion. The increase in plasma glucose results in an increase in plasma insulin and a subsequent drop in plasma glucose during the initial period of the activity, resulting in quick exhaustion. In contrast, glucose solutions ingested from 5 minutes to immediately prior to exercise result in maintenance of the blood glucose level throughout moderate- to high-intensity exercise.

The benefits of carbohydrate consumption during exercise are generally well known. A general recommendation is that 20 to 60 g of carbohydrate be consumed every hour during prolonged exercise. Increased post-exercise intake of carbohydrates is also generally recommended to aid in recovery and enhance performance during exercise.

There are presently a substantial number of electrolyte drinks on the market that are alleged to replenish essential electrolytes and water lost from the body during physical activity. Such drinks offer a variety of electrolyte combinations by the name of ‘Activity drinks’, ‘Sports drinks’, ‘Energy drinks’ or ‘Nutrient drinks’. Such drinks are reported to solve problems with respect to the loss of carbohydrates, electrolytes, vitamins, minerals, amino acids, and other important nutrients, which occurs during heavy exercise. Such products are, however, generally unpalatable and do not, in fact, satisfy the body completely by replenishing all the essential constituents which are lost.

The present invention provides a multi-electrolyte composition including water, fructose, inulin, and flavoring to provide a more palatable drink with a better balance of electrolytes. This isotonic energy drink also includes critical vitamins, minerals, and amino acids as important nutrients for optimum performance.

### SUMMARY OF THE INVENTION

The invention comprises a beverage product for direct increase of blood sugars and salts typically lost during athletic exercise. Simple sugars and critical vitamins and minerals are blended in water to provide an electrolyte solution for consumption before, during and after physical exertion.

It is, therefore, an object of the present invention to enable beverage compositions for use in rehydration and nutrition during athletic exercise that avoids the disadvantages of the prior art.

It is another object of the present invention to enable a method for preparing such beverage compositions.

It is yet another object of the present invention to enable a beverage composition that replaces blood sugars, salts and minerals lost during athletic exercise.

It is more specifically an object of the invention to provide such a beverage composition that is pleasant tasting.

It is another object of the invention to provide a beverage composition having electrolytes in correct physiological quantities to increase the efficiency of the body to utilize sugars and improve muscular activities.

In accordance with the above and other objects, a beverage composition for use in rehydration and nutrition during athletic exercise is disclosed containing optimum quantities of sugars, salts and minerals, such quantities being rapidly absorbed by the body to replace losses of nutrients and fluid volume associated with such exercise.

The various features of novelty that characterize the invention will be pointed out with particularity in the claims of this application.

### DETAILED DESCRIPTION OF THE INVENTION

The invention summarized above may be better understood by referring to the following description. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In a first embodiment, a high-energy electrolyte beverage is mixed together using water, sweeteners, citric acid, flavoring and a blend of vitamins and minerals. The combination of vitamins and minerals includes Vitamin A, Vitamin E, Niacin, Pantothenic Acid, Vitamin B1, Vitamin B12, Vitamin B2, Vitamin B6, Vitamin C, Calcium, Chloride, Chromium, Copper, Magnesium, Phosphorus, Potassium, Sodium, and Zinc. Additional ingredients include L-Isoleucine, L-Leucine, and L-Valine.

In a preferred embodiment, a powder premixture is formulated comprising the following composition:

| | | |
|---|---|---|
| Vitamin A (as Palmitate, USP-FCC) | 500-2000 | IU |
| Vitamin E (as acetate, USP) | 10-30 | IU |
| Niacin (as Niacinamide, USP-FCC) | 5-25 | mg |
| Pantothenic Acid (as D-Calcium Pantothenate, USP) | 2-10 | mg |
| Vitamin B1 (as Thiamin HCl, USP-FCC) | 0.1-1 | mg |
| Vitamin B12 (as Cyanocobalamin, USP) | 1-10 | mcg |
| Vitamin B2 (as Riboflavin, USP-FCC) | 0.45-0.95 | mg |
| Vitamin B6 (as Pyridoxine HCl, USP-FCC) | 0.5-3 | mg |
| Vitamin C (as Ascorbic Acid, USP-FCC) | 10-50 | mg |
| Calcium (as Calcium Citrate, USP-FCC) | 50-200 | mg |
| & (Gluconal Cal) | | |
| Chloride (as Magnesium Chloride, Anhydrous) | 100-350 | mg |
| & (Sodium Chloride, FCC) | | |
| Chromium (as Chromium Chloride (6H₂O), USP) | 10-45 | mcg |
| Copper (as Copper Sulfate) | 0.1-4 | mg |
| Magnesium (as Magnesium Chloride, Anhydrous) | 25-60 | mg |
| Phosphorous (as Dipotassium Phosphate, FCC) | 100-400 | mg |
| & (Monosodium Phosphate) | | |
| Potassium (as Dipotassium Phosphate, FCC) | 200-400 | mg |
| Sodium (as Monosodium Phosphate, FCC) | 100-350 | mg |
| & (Sodium Chloride, FCC) | | |
| Zinc (as Zinc Sulfate, USP-FCC) | 5-10 | mg |
| L-Isoleucine (USP) | 15-75 | mg |
| L-Leucine (USP) | 30-75 | mg |
| L-Valine (USP) | 15-75 | mg |

Approximately 2.65 grams of the premixture is used for an 8 fluid ounce serving. Preferably, the premixture contains:

| | | |
|---|---|---|
| Vitamin A (as Palmitate, USP-FCC) | approximately 1000 | IU |
| Vitamin E (as acetate, USP) | approximately 15 | IU |
| Niacin (as Niacinamide, USP-FCC) | approximately 10 | mg |
| Pantothenic Acid (as D-Calcium | approximately 5 | mg |
| Pantothenate, USP) | | |
| Vitamin B1 (as Thiamin HCl, USP-FCC) | approximately 0.75 | mg |
| Vitamin B12 (as Cyanocobalamin, USP) | approximately 3 | mcg |
| Vitamin B2 (as Riboflavin, USP-FCC) | approximately 0.85 | mg |
| Vitamin B6 (as Pyridoxine HCl, USP-FCC) | approximately 1 | mg |
| Vitamin C (as Ascorbic Acid, USP-FCC) | approximately 30 | mg |
| Calcium (as Calcium Citrate, USP-FCC) | approximately 100 | mg |
| & (Gluconal Cal) | | |
| Chloride (as Magnesium Chloride, | approximately 170 | mg |
| Anhydrous) & (Sodium Chloride, FCC) | | |
| Chromium (as Chromium Chloride (6H₂O), | approximately 24 | mcg |
| USP) | | |
| Copper (as Copper Sulfate) | approximately 1 | mg |
| Magnesium (as Magnesium Chloride, | approximately 40 | mg |
| Anhydrous) | | |
| Phosphorous (as Dipotassium Phosphate, | approximately 250 | mg |
| FCC) & (Monosodium Phosphate) | | |
| Potassium (as Dipotassium Phosphate, FCC) | approximately 350 | mg |
| Sodium (as Monosodium Phosphate, FCC) | approximately 120 | mg |
| & (Sodium Chloride, FCC) | | |
| Zinc (as Zinc Sulfate, USP-FCC) | approximately 7.5 | mg |
| L-Isoleucine (USP) | approximately 50 | mg |
| L-Leucine (USP) | approximately 60 | mg |
| L-Valine (USP) | approximately 50 | mg |

The beverage is prepared by heating a quantity of water to approximately 150° F. A sufficient amount of Raftilose and Fructose are added and mixed thoroughly until dissolved. A sufficient amount of Sucralose and Acesulfame-K are added and mixed thoroughly until dissolved. A quantity of premixture of the vitamins and minerals is added and mixed thoroughly until dissolved. Once the ingredients are thoroughly combined, debittering agents and a vitamin masking agent are added. Next, a sufficient quantity of Citric Acid is added to adjust the pH to approximately 4.0. Then flavoring may be added.

Following blending of the beverage solution, the admixture is sterilized and homogenized. The solution is heated to approximately 200° F. for about 10 seconds at 1000 psi. While still hot, the solution is placed in bottles, sealed and quick cooled, by plunging a sealed bottle in an ice bath.

Each 8-ounce serving comprises the following approximate constituents:

| | | |
|---|---|---|
| Oligofructose-Raftilose P95-Pwd RHF | approximately 5.77 | g |
| Krystar Crystalline Fructose-Sweetener STC | approximately 21.57 | g |
| Sweetener-Splenda MNP | approximately 0.042 | g |
| Acesulfame-K (Potassium)-Sweetener RCC | approximately 0.018 | g |
| Premixture | approximately 2.65 | g |
| Natural Flavor (OSF 1.01) | approximately 1.53 | g |
| Citric Acid-Anhydrous (Acidulent) HRC | approximately 2.4 | g |
| Water | approximately 569 | g |

The premixture is blended to provide the following approximate nutritional components:

| | |
|---|---|
| Calcium | 10% DV |
| Phosphorous | 25% |
| Magnesium | 10% |
| Chloride | 5% |
| Sodium | 5% |
| Potassium | 10% |
| Vitamin A | 20% |
| Vitamin C | 50% |
| Vitamin E | 50% |
| B1 | 50% |
| B2 | 50% |
| Niacin | 50% |
| B6 | 50% |
| B12 | 50% |
| Pantothenic Acid | 50% |
| Zinc | 50% |
| Copper | 50% |
| Chromium | 20% |
| L-Leucine | 60 mg |
| L-Isoleucine | 50 mg |
| L-Valine | 50 mg |

Each 8-ounce serving contains the following approximate nutrients per serving:

| | |
|---|---|
| Calories | 106.78 |
| Protein | 0.22 g |
| Carbohydrates | 30.85 g |
| Dietary Fiber | 5.45 g |
| Fat - total | 0.00 g |
| Saturated Fat | 0 g |
| % calories from fat | 0% |
| % calories from carbs | 99% |
| Vitamin A RE | 0.43 RE |
| Vitamin C | 30.08 mg |

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A liquid beverage product for consumption by humans to be used as a rehydration drink, said beverage product comprising:
(A) Vitamin A;
(B) Vitamin E;
(C) Niacin;
(D) Pantothenic Acid;
(E) Vitamin B1;
(F) Vitamin B12;
(G) Vitamin B2;
(H) Vitamin B6;
(I) Vitamin C;
(J) calcium;
(K) chloride;
(L) chromium;
(M) copper;
(N) magnesium;
(O) phosphorous;
(P) potassium;
(Q) sodium;
(R) zinc;
(S) isoleucine;
(T) leucine;
(U) valine; and
(V) water in a quantity at least sufficient for providing a solution wherein components (A) to (U) are substantially dissolved and which solution is ready for consumption by drinking.

2. The beverage product of claim 1, in which the isoleucine is in the form of L-Isoleucine, the leucine is in the form of L-Leucine, and the valine is in the form of L-Valine.

3. The beverage product of claim 1, wherein the ingredients consist essentially of:
(A) about 500 IU to about 2000 IU of Vitamin A;
(B) about 15 IU to about 30 IU of Vitamin E;
(C) about 5 mg to about 25 mg of Niacin;
(D) about 2 mg to about 10 mg of Pantothenic Acid;
(E) about 0.1 mg to about 1 mg of Vitamin B1;
(F) about 1 mcg to about 10 mcg of Vitamin B12;
(G) about 0.45 mg to about 0.95 mg of Vitamin B2;
(H) about 0.5 mg to about 3 mg of Vitamin B6;
(I) about 10 mg to about 50 mg of Vitamin C;
(J) about 50 mg to about 200 mg of calcium;
(K) about 100 mg to about 350 mg of chloride;
(L) about 10 mcg to about 45 mcg of chromium;
(M) about 0.1 mg to about 4 mg of copper;
(N) about 25 mg to about 60 mg of magnesium;
(O) about 100 mg to about 400 mg of phosphorous;
(P) about 200 mg to about 400 mg of potassium;
(Q) about 100 mg to about 350 mg of sodium;
(R) about 5 mg to about 10 mg of zinc;
(S) about 15 mg to about 75 mg of isoleucine;
(T) about 30 mg to about 75 mg of leucine; and
(U) about 15 mg to about 75 mg of valine.

4. The beverage product of claim 1, wherein the ingredients consist essentially of:
(A) approximately 1000 IU of Vitamin A;
(B) approximately 15 IU of Vitamin E;
(C) approximately 10 mg of Niacin;
(D) approximately 5 mg of Pantothenic Acid;
(E) approximately 0.75 mg of Vitamin B1;
(F) approximately 3 mcg of Vitamin B12;
(G) approximately 0.85 mg of Vitamin B2;
(H) approximately 1 mg of Vitamin B6;
(I) approximately 30 mg of Vitamin C;
(J) approximately 100 mg of calcium;
(K) approximately 170 mg of chloride;
(L) approximately 24 mg of chromium;
(M) approximately 1 mg of copper;
(N) approximately 40 mg of magnesium;
(O) approximately 250 mg of phosphorous;
(P) approximately 350 mg of potassium;
(Q) approximately 120 mg of sodium;
(R) approximately 7.5 mg of zinc;
(S) approximately 50 mg of isoleucine;
(T) approximately 60 mg of leucine; and
(U) approximately 50 mg of valine.

5. A method of preparing a liquid beverage product for consumption by humans for restoring human growth hormone, said method comprising the steps of:
(A) heating a quantity of water to approximately 150° F.;
(B) adding a sufficient quantity of a natural sweetener and dissolving such sweetener in the water;
(C) adding a sufficient quantity of a premixture and dissolving such premixture in the water;
(D) after thoroughly dissolving all ingredients in the water, adding debittering agents and a vitamin masking agent;
(E) adding a sufficient quantity of citric acid to adjust the pH to approximately 4.0.

6. The method of claim 5, in which such natural sweeteners are selected from the group consisting of:
(A) Raftilose;
(B) Fructose;
(C) Sucralose; and
(D) Acesulfame-K.

7. The method of claim 5, in which such premixture comprises:
(A) about 500 IU to about 2000 IU of Vitamin A;
(B) about 15 IU to about 30 IU of Vitamin E;
(C) about 5 mg to about 25 mg of Niacin;
(D) about 2 mg to about 10 mg of Pantothenic Acid;
(E) about 0.1 mg to about 1 mg of Vitamin B1;
(F) about 1 mcg to about 10 mcg of Vitamin B12;
(G) about 0.45 mg to about 0.95 mg of Vitamin B2;
(H) about 0.5 mg to about 3 mg of Vitamin B6;
(I) about 10 mg to about 50 mg of Vitamin C;
(J) about 50 mg to about 200 mg of calcium;
(K) about 100 mg to about 350 mg of chloride;
(L) about 10 mcg to about 45 mcg of chromium;
(M) about 0.1 mg to about 4 mg of copper;
(N) about 25 mg to about 60 mg of magnesium;
(O) about 100 mg to about 400 mg of phosphorous;
(P) about 200 mg to about 400 mg of potassium;
(Q) about 100 mg to about 350 mg of sodium;
(R) about 5 mg to about 10 mg of zinc;
(S) about 15 mg to about 75 mg of isoleucine;
(T) about 30 mg to about 75 mg of leucine; and
(U) about 15 mg to about 75 mg of valine.

8. The method of claim 5, further comprising the step of:
(F) adding a flavoring agent.

9. The method of claim 5, further comprising the steps of:
(G) sterilizing and homogenizing such solution; and
(H) dividing such solution into smaller quantities for bottling.
